(19) United States
(12) Patent Application Publication
(10) Pub. No.: US 2005/0203837 A1
(43) Pub. Date: Sep. 15, 2005

(54) Direct deposit donation

(76) Inventors: Erin Leigh, Wyckoff, NY (US); Peter Thomas Finelli, New York, NY (US)

Correspondence Address: Erin Leigh Wyckoff;Apt. 29J, 303 East 83rd Street, New York, NY, 10028, US

(21) Appl. No.: 10/798,747

(22) Filed: Mar. 12, 2004

(51) Int. Cl. G06F 17/60

(52) U.S. Cl. 705/39

(57) ABSTRACT

Direct Deposit Donation requires the automatic deduction of money from one's paycheck to an electronic donation receptacle. This money would be donated and tracked based on the employee's employee identification number.

### BACKGROUND OF THE INVENTION

This invention pertains to the field of non-profit organizations. It utilizes the technology of direct deposit to transfer an employee's selected amount of funds from his/her paycheck to an electronic deposit station designated for that employee's chosen donation organization.

### BRIEF SUMMARY OF THE INVENTION

With each paycheck, the Direct Deposit Donation will automatically deduct an agreed upon amount from the employee's paycheck. This deducted amount will be donated to a non-profit organization (ex. Cancer Research Institute, American Heart Association, etc.), which was predetermined by the employee. The advantage of this invention is that it allows people to give back to society and humanity without having to stop and make the effort. All the employee needs to do is fill out a brief Direct Deposit Donation form, indicating his/her personal information (name, address, pay stub number, etc.), chosen organization for donations, and how much to be donated per paycheck. Once that step is completed, the donations are directly deposited to the organization with each paycheck. Too often people want to contribute to the well-being of humankind, but they simply get lazy or forget to keep up with it. Direct Deposit Donation forgives one's laziness and forgetfulness. It simply remembers and acts for the employee. When one considers that staggering number of workers out there, Direct Deposit Donation has the potential to raise a momentous amount of money for non-profit organizations.

### DETAILED DESCRIPTION OF THE INVENTION

Direct Deposit Donation could take place in two ways: one, it may begin with the cooperation of non-profit organizations and the various companies/corporations who will choose to provide this option for their employees: Each participating non-profit organization would set up a direct deposit receptacle (most likely electronic) that receives the fund transfers and keeps note of which employees donated said funds. Meanwhile, each participating company/corporation would set up a direct deposit link routed from employees' employee identification number to the aforementioned receptacle. Employees simply fill out the Direct Deposit Donation form once, and all deductions for donation occur automatically from that point on.

Direct Deposit Donation could also carry on via a middleman service that would serve as a liaison between the non-profit organizations and the companies/corporations. This service would relieve the non-profit organization of the burden of employee donation tracking. In other words, the organization's only part to be played is passive: it would simply receive a large check from the middleman service (perhaps once a month). In other words, the middleman service would provide the electronic receptacle for donations, and it would be responsible for maintaining employee donation records. If this were the case, then Direct Deposit Donation would begin with the cooperation of the middleman service and the companies/corporations. The middleman service would be responsible for selling this invention to the company/corporation. This removal of the non-profit organization as an active participant would also allow the employees to choose any non-profit organization they want for their donations. In either case, the invention, Direct Deposit Donation, is being implemented. In either case, an extraordinary amount of money that would originally have been used for an employee's personal needs will be automatically donated to the noble cause of humanity. All it takes is a few dollars a pay check. If enough companies/corporations choose to participate in allowing their employees to make this automatically deducted donation, millions of dollars could be donated.

1. We claim that the invention is the concept of automatically deducting money from one's paycheck and transferring these funds as a donation to the employee's organization of choice (direct deposit).

2. We claim that the invention is the creation of a middleman service that is responsible for promoting, receiving, tracking, and ultimately donating the directly deposited funds to the various non-profit organizations.
